(19) United States
(12) Patent Application Publication
(10) Pub. No.: US 2024/0089721 A1
(43) Pub. Date: Mar. 14, 2024

(54) EXPLICIT NOTIFICATIONS

(71) Applicant: NOKIA SOLUTIONS AND NETWORKS OY, Espoo (FI)

(72) Inventors: Martin KONECNY, Prague (CZ); Kiran SATHYANARAYANAMURTHY, Bangalore (IN); Narasimha Rao PULIPATI, Bellevue, WA (US)

(21) Appl. No.: 18/263,228

(22) PCT Filed: Nov. 29, 2021
(86) PCT No.: PCT/FI2021/050819

§ 371 Date: Jul. 27, 2023

(30) Foreign Application Priority Data
Feb. 4, 2021 (FI) 20215117

(51) Int. Cl. H04W 8/18; H04L 65/1073

(52) U.S. Cl. CPC H04W 8/18; H04L 65/1073

(57) ABSTRACT

To update subscription related information using explicit notifications different solutions resulting to a notification updating information relating to a plurality of subscriptions per a network function are disclosed.

### TECHNICAL FIELD

Various example embodiments relate to wireless communications.

### BACKGROUND

Wireless communication systems are under constant development. Operations, Administration and Management (OAM) functions as well as core network functions are also developing.

### BRIEF DESCRIPTION

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to an aspect there is provided an apparatus comprising at least one processor; and at least one memory including computer program code, the at least one memory and computer program code configured to, with the at least one processor, cause the apparatus at least to perform: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process.

In an embodiment, the at least one memory and computer program code configured to, with the at least one processor, cause the apparatus further to at least to perform: providing in the user tool also a field for one or more service names provided by the one or more serving nodes.

In embodiments, the at least one memory and computer program code configured to, with the at least one processor, cause the apparatus further to perform: providing in the user tool also a field for one or more public mobile network identifiers.

According to an aspect there is provided an apparatus comprising at least one processor; and at least one memory including computer program code, the at least one memory and computer program code configured to, with the at least one processor, cause the apparatus at least to perform: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

In an embodiment, the at least one memory and computer program code configured to, with the at least one processor, cause the apparatus further to at least to perform: determining, in response to the information on one or more network nodes to be notified comprising one or more network function types and one or more service names, the one or more network nodes by performing a network function endpoint discovery.

In an embodiment, the at least one memory and computer program code configured to, with the at least one processor, cause the apparatus further to at least to perform: using, in response to the request comprising one or more public mobile network identifiers, also the one or more public mobile network identifiers when determining the one or more network nodes.

In embodiments, the at least one memory and computer program code configured to, with the at least one processor, cause the apparatus further to at least to perform: determining, in response to the request containing default call back address information without authority and one or more service names, one or more default call back addresses by performing a network function endpoint discovery based on the one or more network nodes and the one or more service names.

In embodiments, the request is received from a front end apparatus.

In embodiments, the request is received from a rule-based tool.

In embodiments, the at least one memory and computer program code configured to, with the at least one processor, cause the apparatus further to at least to perform: providing the rule-based tool as a rule based machine learning tool, configured to determine, based on one or more rules, information on mobile subscription identifiers an explicit notification should be created, and a process to be performed, and to create the request correspondingly.

In embodiments, the at least one memory and computer program code configured to, with the at least one processor, cause the apparatus further to at least to perform: monitoring changes in data relating to subscription information; checking, in response to detecting a change relating to subscription information, whether one or more rules apply; and causing creating and sending a request in response to one or more rules applying.

According to an aspect there is provided a method comprising: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process.

According to an aspect there is provided a method comprising: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

According to an aspect there is provided a computer-readable medium comprising program instructions, which, when run by an apparatus, causes the apparatus to carry out at least: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process.

According to an aspect there is provided a computer-readable medium comprising program instructions, which, when run by an apparatus, causes the apparatus to carry out at least: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

According to an aspect there is provided a computer-readable medium comprising program instructions, which, when run by an apparatus, causes the apparatus to carry out at least one of a first method or a second method, wherein the first method comprises at least: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process; wherein the second method comprises at least: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

According to an aspect there is provided a non-transitory computer-readable medium comprising program instructions, which, when run by an apparatus, causes the apparatus to carry out at least: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process.

According to an aspect there is provided a non-transitory computer-readable medium comprising program instructions, which, when run by an apparatus, causes the apparatus to carry out at least: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

According to an aspect there is provided a non-transitory computer-readable medium comprising program instructions, which, when run by an apparatus, causes the apparatus to carry out at least one of a first method or a second method, wherein the first method comprises at least: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process; wherein the second method comprises at least: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

According to an aspect there is provided a computer program comprising instructions which, when the program is executed by an apparatus, cause the apparatus apparatus to carry out at least: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process.

According to an aspect there is provided a computer program comprising instructions which, when the program is executed by an apparatus, cause the apparatus apparatus to carry out at least: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

According to an aspect there is provided a computer program comprising instructions which, when the program is executed by an apparatus, cause the apparatus apparatus to carry out at least one of a first method or a second method, wherein the first method comprises at least: providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data; receiving as user input in the tool at least information on one or more network nodes to be notified, one or more user device context management service name as the one or more unified data management endpoints and information on mobile subscription identifiers the notification relates to; creating, in response to a user input selecting one of the selection options, per a unified data management endpoint, a request for an explicit notification, the request containing received user input and the selected process; and causing sending, per the unified data management endpoint, the request to the unified data management endpoint to cause performance of the selected process; wherein the second method comprises at least: receiving a request for an explicit notification to one or more serving nodes, the request containing at least information on one or more network nodes to be notified, information on mobile subscription identifiers the notification relates to, and a process to be performed; and causing sending, per a network node, to the one or more network nodes an explicit notification to perform the process, the explicit notification comprising the information on mobile subscription identifiers.

### BRIEF DESCRIPTION OF DRAWINGS

Embodiments are described below, by way of example only, with reference to the accompanying drawings, in which

FIG. 1 illustrates an exemplified wireless communication system;

FIGS. 2 and 3 are schematic block diagrams;

FIGS. 4 to 10 are flow charts illustrating different examples of functionalities; and

FIGS. 11 and 12 are schematic block diagrams.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first element could be termed a second element, and similarly, a second element could be also termed a first element without departing from the scope of the present disclosure.

Embodiments and examples described herein may be implemented in any communications system comprising wireless connection(s). In the following, different exemplifying embodiments will be described using, as an example of an access architecture to which the embodiments may be applied, a radio access architecture based on new radio (NR, 5G) or long term evolution advanced (LTE Advanced, LTE-A), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), beyond 5G, wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

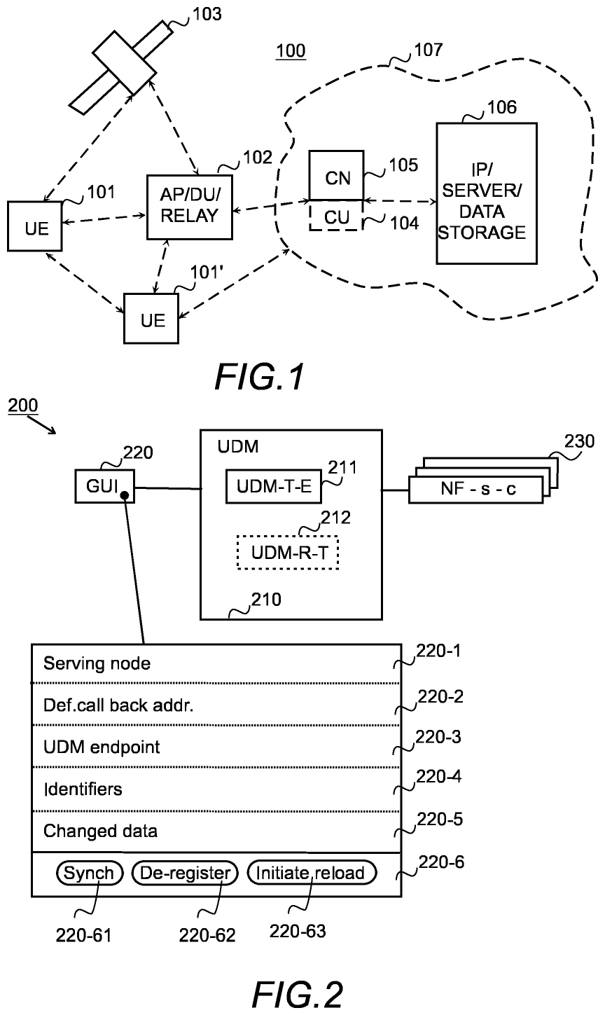

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 101 and 101′ configured to be in a wireless connection on one or more communication channels in a cell with an access node (such as (e/g)NodeB) 102 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point (AP) etc. entity suitable for such a usage.

A communications system 100 typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 105 (CN or next generation core NGC). Depending on the system, the counterpart on the CN side can be a serving gateway (SGW, routing and forwarding user data packets), packet data network gateway (P-GW), for providing connectivity of user devices (UEs) to external packet data networks, or mobile management entity (MME), access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus.

The user device typically refers to a portable computing device that includes wireless mobile communication devices operating with a subscription entity, for example a subscriber identification module (SIM), including, but not limited to, the following types of wireless devices: a mobile station (mobile phone), smartphone, personal digital assistant (PDA), handset, device using a wireless modem (alarm or measurement device, etc.), laptop and/or touch screen computer, tablet, game console, notebook, wearable device, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes or corresponding network devices than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multiaccess edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as relay nodes, for example distributed unit (DU) parts of one or more integrated access and backhaul (IAB) nodes, or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

In 5G and beyond 5G, the core network, so called next generation core, or 5G core, 5GC, may be based on Service-Based Architecture (SBA). Elements (functional units) of service based architecture are defined using network functions (NFs). A network function supports or hosts a collection of services and offers one or more services to other network functions in the network.

FIG. 2 is a schematic block diagram illustrating a high-level architecture of a next generation core system 200 in point of view of subscription data management service function node, or shortly an UDM (user data management).

Referring to FIG. 2, in the illustrated example the UDM 210 is assumed to be, for the sake of clarity of description, a stateful entity that is configured to store information, such as user subscription data (user subscription data), policy data, structured data for exposure, and application-level meta data, such as packet flow descriptions, etc. in its local memory. However, the UDM 210 may be a stateless entity, wherein the information may be stored externally in a unified data repository (UDR), the UDM then being a front-end for the user subscription data, for example. It should be appreciated that the way how and where the information is stored bears no significance to solutions described herein. The UDM offers for other network functions, called network function service consumers (NF-s-c) 230, subscriber data management services, context management services, authentication services, event exposure services, parameter provision services, authorization services, and mobile terminating services, for example. In the illustrated example, the UDM 210 is configured to comprise one or more trigger processing entities (UDM-T-E) 211, example functionalities of which are described below with FIGS. 6 to 8. Naturally, any other way to configure the UDM to perform corresponding functionality or functionalities may be used. The UDM 210 may also comprise one or more rule-based tools (UDM-R-T) 212. The rule-based tool 212 may be based on a rule-based machine learning and/or user input rules. The rule-based tool may be configured to determine, based on one or more rules, information on mobile subscription identifiers an explicit notification should be created, and a process to be performed, and to create the request correspondingly.

In the illustrated example of FIG. 2, the core system 200 comprises, as front end apparatuses, one or more apparatuses with user interfaces 220, for example graphical user interfaces (GUI), via which users can create requests for the UDM 210 (for the one or more trigger processing entities 211) to create explicit notifications (requests for explicit notifications, a request for an explicit notification). For that purpose, the tool may comprise, as illustrated in FIG. 2, following:
a field 220-1 for one or more serving nodes,
a field 220-2 for one or more default call back address information,
a field 220-3 for one or more UDM endpoints,
a field 220-4 for subscription identifiers,
a field 220-5 for changed data, and
a process selection portion 220-6.

The information in the field 220-1 for the one or more serving nodes is information on one or more network function service customers 230 that are to be notified. The information provided in the field may be generalized to contain a serving function name thereby covering all nodes connected to the UDM and providing the service function. The field 220-2 for the default call back address information may comprise one or more uniform resource identifiers (URIs), or corresponding address information, a uniform resource identifier (URI) indicating where a resource for a serving node in the field 220-1 can be found, the resource being, for example, for notifications indicating error situations. The field 220-3 for the UDM endpoints may contain an address to a sub-service in the UDM. In other words, if the UDM has service separation, for example per a service type, like a sub-service for context management (UE-CM), with the use of this field the request will reach the intended sub-service. The information in the field 220-4 may comprise a plurality of subscription identifiers, for example as a subscriber identifier range and/or a list comprising two or more subscriber identifiers, to which the notification, and thereby the process to be performed, relates to. The field for changed data 2205 provides a possibility to update (send) the modified part of a resource, not the entire resource. It should be appreciated that the field 220-5 may be left empty.

The process selection portion 220-6 displays the processes amongst which the user of the tool may select a process to be performed. In the illustrated example, the processes include synchronization of data (Sync) 220-61, de-registering (Deregister) 220-62 and initiating reloading (Initiate reload) 220-63. It should be appreciated that further processes may be added to the selection portion.

It should be appreciated that an apparatus with a user interface 220 may locate in operations, administration and management (OAM) system as well.

The one or more network function service consumer nodes 230 may include, for example, one or more access and mobility management function nodes (AMF), one or more session management function nodes (SMF), one or more short message service function nodes (SMSF), one or more aauthentication server function nodes (AUSF), one or more network exposure function nodes (NEF), one or more gateway mobile location centres (GMLC), one or more home subscriber server (HSS), and/or one or more network data analytics function (NDWAF). It should be appreciated that the list of examples is a non-limiting list.

Even though not illustrated above, the UDM 210 may comprise sub-services, for example per a network function service consumer type.

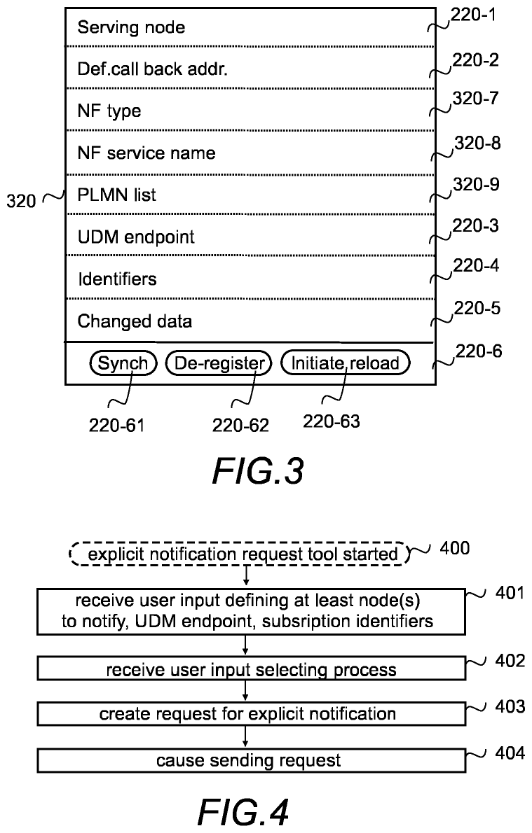

FIG. 3 illustrates another example of what a tool displayed on a graphical user interface may comprise. As can be seen from FIG. 3, the tool 320, comprises, in addition to the fields 220-1, 220-2, 220-3, 220-4, 220-5 and process selection portion 220-6 described with FIG. 2, additional fields. In the illustrated example, the additional fields are a field 320-7 for one or more network function types (NF type), a field 320-8 for one or more network function service names (NF service name) and a field 320-9 for one or more public mobile phone network identifiers (PLMN list). The additional fields may be used for defining network nodes whereto notifications are sent. For example, if the person using the tool does not know the default call back address, the person may left field 220-2 empty and provide information to the field 320-8, i.e. input one or more network function service names.

It should be appreciated that any of the additional fields illustrated in FIG. 3 may be left out.

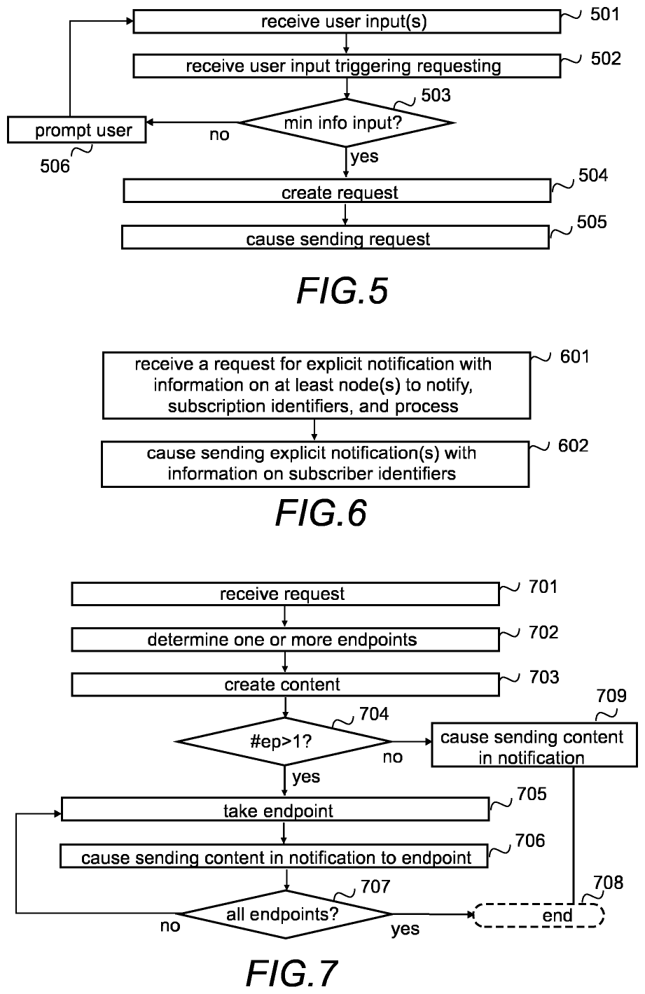

FIGS. 4 and 5 illustrate different example functionalities of an apparatus comprising the tool to request creation of explicit notifications.

Referring to FIG. 4, the explicit notification tool in the apparatus has been started and the fields and selection options are displayed. Then user inputs are received in block 401, the user inputs defining at least one or more nodes to notify, one or more UDM endpoints and a plurality of subscription identifiers. Information defining the one or more nodes to notify may be information inputted to the field for the serving node, or information inputted to the field for the serving node and to the field for one or more public mobile phone network identifiers, or information inputted to the field for one or more network function types and the field for one or more network function service names, or information inputted to the field for one or more network function types and the field for one or more network function service names and to the field for one or more public mobile phone network identifiers. Information defining an UDM endpoint is information inputted to the field for one or more UDM endpoints. Information defining the plurality of subscription identifiers is information inputted to the field for subscription identifiers, inputted as a range of subscription identifiers or as a list comprising two or more subscription identifiers. The user inputs received in block 401 may further comprise information inputted to the field for one or more call back address information and/or information inputted to the field for changed data.

Then a user input selecting a process to be performed is received in block 402, causing that a request for an explicit notification is created (generated), per an UDM endpoint, in block 403, and sending the request, per the UDM endpoint is caused in block 404.

Below some examples are described using, for the sake of description, using as a subscription permanent identifier (SUPI) an international mobile subscriber identity (IMSI), without limiting the examples to such subscription identifiers.

Assuming that a trial pack has expired and therefore subscription information for a range of subscribers has to be deleted, but for some reason the sub-service for context management UE-CM failed to notify AMF, the failure being noticed in the operations, administration and management system, causing that a person opens the tool to create requests for explicit notifications and inputs to the tool corresponding information. For example, using the tool in FIG. 2, if the input received in block 401 is to field 220-1 (serving node) is AMF, to field 220-2 (def. call back address) is https://amf.nokia.com/deregistration, to field 220-3 (UDM endpoint) is https://uecm.nokia.com/deregistration, and to field 220-4 (identifiers) is {SUPI:{imsi-10982323233,imsi-10982323300}} and the process selected in block 402 is de-registration, the content of the request created in block 403 may be, when Javascript Object notation (JSON) is used, as follows:

{
″explicitTriggerNotif″:{
″servingNode″:″AMF:,
″defaultCallBackUri″:″https://amf.nokia.com/deregistration″,
″udmEndPoint″:″https://uecm.nokia.com/deregistration″,
″affectedIdentifiers”: {
″key″:″SUPI″,
″range″: {
″from″:″imsi-10982323233″,
″to″:″imsi-10982323300″ ,
}
},
″triggerOperation″:″Deregister″
}
}

Assuming that it is detected in the operations, administration and management system, that subscription information on a sub-set of subscribers is not the same, in the example, in nodes in two public mobile phone networks, causing that a person opens the tool to create requests for explicit notifications and inputs to the tool corresponding information to synchronize data. Using the tool in FIG. 3, if the input received in block 401 is to field 220-1 (serving node) is AMF, to field 220-2 (def. call back address) is https://amf.noki.com/notify, to field 320-8 (service name) is custom, to field 320-9 (PLMN list) is {311487, 311281}, to field 220-3 (UDM endpoint) is https://uecm.nokia.com/notify, to field 220-4 (identifiers) is {SUPL{imsi-10982323233,imsi-10982323300}} and to field 220-5 (changed data) are access and mobility data (am-data) and network slice selection assistance information (nssai), and the process selected in block 402 is synchronize data, the content of the request created in block 403 may be, when Javascript Object notation (JSON) is used, as follows:

{
″explicitTriggerNotif″:{
″servingNode″:″AMF:,
″defaultCallBackUri″:″https://amf.nokia.com/notify″,
“serviceName”: “custom”,
“plnmnList”: {“311487”, “311281”},
″udmEndPoint″:″https://uecm.nokia.com/notify″,
″affectedIdentifiers”: {
″key″:″SUPI″,
″range″: {
″from″:″imsi-10982323233″,
″to″:″imsi-10982323300″
}
},
“affectedResources”: {
“am-data”,
“nssai”
},
″triggerOperation″:″Synchronize-Data″
}
}

Assuming that for some reason subscription information on a sub-set of subscribers is temporarily not available, and shared data applicable, in the example, to two public mobile phone networks is updated, one should ensure that the update is conveyed to all nodes. The temporary unavailability is noticed in the operations, administration and management system, causing that a person opens the tool to create requests for explicit notifications and inputs to the tool corresponding information to reload data. Using the tool in FIG. 3, if the input received in block 401 is to field 220-1 (serving node) is AMF, to field 220-2 (def. call back address) is https://amf.noki.com/notify, to field 3208 (service name) is custom, to field 320-9 (PLMN list) is {311487, 311281}, to field 2203 (UDM endpoint) is https://uecm.nokia.com/notify, to field 220-4 (identifiers) is {SUPI:{imsi-10982323233,imsi-10982323300}}, and the process selected in block 402 is initiate reloading of the data, the content of the request created in block 403 may be, when Javascript Object notation (JSON) is used, as follows:

{
″explicitTriggerNotif″:{
″servingNode″:″AMF:,
″defaultCallBackUri″:″https://amf.nokia.com/notify″,
“serviceName”: “custom”,
“plnmnList”: {“311487”, “311281”},
″udmEndPoint″:″https://uecm.nokia.com/notify″,
″affectedIdentifiers”: {
″key″:″SUPI″,
″range″: {
″from″:″imsi-10982323233″,
″to″:″imsi-10982323300″
}
},
″triggerOperation″:″Initiate-Reload″
}
}

In an implementation, described with FIG. 5, the tool providing the user interface and the fields for user input is configured to ensure that at least minimum information is input so that the UDM can process the request.

Referring to FIG. 5, the user inputs to the different fields of the tool are received in block 501, and the a user input triggering the requesting, i.e. selection of the process, is received in block 502. Then it is checked in block 502 whether minimum information has been input. The minimum information comprises two or more subscriber identifiers (subscription identifiers) and information by means of which the one or more network nodes to be notified can be determined. Examples of the latter are described above with block 401 in FIG. 4. Further, if the process is selected is synchronize, it is checked that data is inputted to the field for changed data.

If the minimum information has been input (block 503: yes), the process creates (generates) in block 504 the request for an explicit notification and sending the request is caused in block 505.

If the minimum information has not been input (block 503: no), the process prompts in block 506 the user to provide further input, preferably prompting what information is missing, and the process continues to block 501 to receive one or more user inputs.

FIG. 6 illustrates an example functionality of the UDM, or the trigger processing entity in the UDM.

Referring to FIG. 6, when a request for an explicit notification is received in block 601, either from the front end apparatus or from the rule-based tool, sending of one or more explicit notifications with information on subscription identifiers received in the request is caused in block 602. The explicit notification causes a serving node (network functionality), which receives the explicit notification, to perform the process that was indicated in the request received in block 601. An explicit notification is sent per a serving node indicated in the request received in block 601. In other words, the request received in block contains information on at least one or more serving nodes to notify, two or more subscription identifiers the notification relates to, and a process to be performed.

FIG. 7 illustrates a more detailed example of functionality of the UDM, or the trigger processing entity in the UDM.

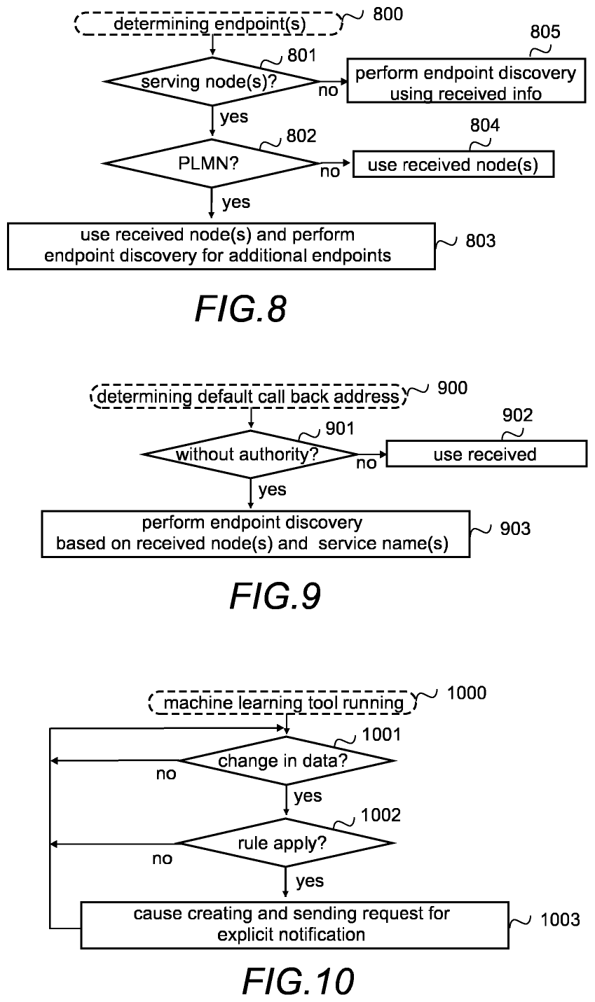

Referring to FIG. 7, when a request for an explicit notification is received in block 701, either from the front end apparatus or from the rule-based tool, one or more endpoints (network function endpoints, i.e. serving nodes) are determined in block 702. Depending on the content of the request, the endpoints (if serving node(s) comprised in the request) in the request may be used as such and/or an endpoint discovery, using the information in the request, may be performed, for example as described below with FIG. 8. Also content for the one or more explicit notifications is created (generated) in block 703, the content comprising at least the two or more subscription identifiers and an indication of a process to be performed. A non-limiting example of the indication of the process is “DeregistrationData”, when JSON is used and the process to be performed is de-registration. The notification may contain also other data (content), for example an instance identifier of the service, session identifier, etc.

In the illustrated example, it is further checked in block 704 how many endpoints (serving nodes) were determined in block 702. If the number of endpoints (#ep) is more than one (block 704: yes), then in the illustrated example, an endpoint is taken in block 705 and sending the content determined in block 703 to the endpoint in an explicit notification is caused in block 706. The explicit notification may be sent using, for example, any HTTP method, such as POST, PUT, PATCH, DELETE, or using chained HTTP methods, for example GET and then PATCH or DELETE or PUT. Then it is checked in block 707 whether an explicit notification has been sent to all determined endpoints. If not (block 707: no), the process returns to block 705 to take an endpoint. If an explicit notification has been sent to all determined endpoints (block 707: yes), the process ends (block 708).

If there is one endpoint (block 704: no), sending the content determined in block 703 to the endpoint in an explicit notification is caused in block 709 and the process ends (block 708).

As can be seen from the above examples of FIGS. 6 and 7, a single notify message can be used for a plurality of subscription identifiers, there is no need to send plurality of notify messages.

FIG. 8 illustrates an example how the UDM, or the trigger processing entity in the UDM, may determine the endpoints (serving nodes).

Referring to FIG. 8, when one or more endpoints are determined (block 800), it is checked in block 801, whether the received request contained information on one or more serving nodes. If it contained information on one or more serving nodes (block 801: yes), it is checked, whether the received request further contained information on one or more public mobile phone networks (PLMN), for example one or more public mobile phone network identifiers. If the request contains, in addition to information on one or more serving nodes, also information on one or more public mobile phone networks (block 802: yes), the information is used to perform in block 803 endpoint discovery, more precisely network function endpoint discovery, to find in the one or more public mobile phone networks network functions providing the same service as the one or more serving nodes to determine one or more additional endpoints, and possibly also a more specific endpoint, if the serving node information is a general level information.

If the request does not contain, in addition to information on one or more serving nodes, also information on one or more public mobile phone networks (block 802: no), the one or more serving nodes are used (block 804) as one or more endpoints.

If the request does not contain information on one or more serving nodes (block 801: no), an endpoint discovery, more precisely network function endpoint discovery, is performed in block 805, using other information in the request, to determine the one or more endpoints. For example, one or more network function types and one or more service names in the request may be used to perform the network function endpoint discovery. Further, if the request also comprises, for example, one or more public mobile network identifiers, they may be used in block 805 to determine the one or more endpoints.

The network function endpoint discovery may be performed using network function service discovery.

FIG. 9 illustrates an example how the UDM, or the trigger processing entity in the UDM, may determine the default call back address (default call back address information).

Referring to FIG. 9, when the default call back address information is determined (block 900), it is checked in block 901, whether the default call back address information in the request is without an authority. The default call back address information in the request is without authority if the address does not indicate a network repository function who authorized the network function. For example, in the above JSONbased examples the default call back addresses are without authority.

If the default call back address information in the request is with an authority (block 901: no), the received default call back address information is used (block 902).

If the default call back address information in the request is without an authority (block 901: yes), an endpoint discovery, more precisely network function endpoint discovery, is performed in block 903, based on one or more network nodes and one or more service names in the request, to determine the default call back address information.

FIG. 10 illustrates an example functionality of a rule-based machine learning tool.

Referring to FIG. 10, when the rule-based machine learning tool is running, it monitors, whether one or more changes in data relating to subscription information is detected. For example, UDM and/or the unified data repository (UDR) and/or home subscriber server(s) (HSS) and/or access function (AF) and/or network exposure function (NEF), etc. may be monitored. The monitoring is continued (block 1001:no) as long as one or more changes in the data relating to subscription information is detected.

When one or more changes in the data relating to subscription information is detected (block 1001: yes), it is checked in block 1002, whether one or more rules apply. A rule may be that the changed data is in one or more logs, or that one or more key performance indicators indicates an error, or that the changed data is caused by swap (changing subscription identifiers due to data being compromised).

If no rule applies (block 1002: no), the monitoring (block 1001) is continued. However, if one or more rules apply (block 1002: yes), creating and sending a request for an explicit notification, the request containing corresponding information described above with user inputs, is caused in block 1003, after which the monitoring (block 1001) is continued. The request generated by the rule-based machine learning tool may be in a form of a command.

For example, if the rule is logs, and changes indicate that subscriber information, or corresponding information cannot be found in any log, the request is created to provision the subscribers. If the rule related to one or more key performance indicators, indicating for example that deregistration or profile update failed leading to unsynchronized data, the request is created to synchronize the data. If data is changed due to swapping, the subscription identifiers compromised may be cancelled by creating the request to deregister the subscription identifiers. Further, a request to provision new subscription identifiers may be created and sent.

In other words, data mining of the rule-based machine learning tool is mining patterns from data called operation and maintenance data, for example from configuration management (CM) and/or from fault management (FM), and/or from performance management (PM), and/or from recorded network events and patterns and/or from specific logging/metrics enabled by one or more network functions. The rule-based machine learning tool is a knowledge base that has rule based classification, decision trees and uses pruning. The knowledge base may be constructed and/or adapted via feature injection, for example using a specific PATCH method to access the rules.

Further, non-limiting list of examples wherein the rule-based machine learning tool may be used for creating one or more requests for explicit notifications include the rule being a health of the system, or external data feed or profile data or traffic patterns or resource consumption patterns, or the changed data is caused by migration or restoration operations or profile optimizations or data extraction and feed, or changed data preparation based on one or more rules and scheduled updates or priority updated, or explicit triggering of one or more services based on one or more rules.

The blocks, related functions, and information exchanges described above by means of FIGS. 2 to 10 are in no absolute chronological order, and some of them may be performed simultaneously or in an order differing from the given one. Other functions can also be executed between them or within them, and other information may be transmitted, and/or other rules applied. Some of the blocks or part of the blocks or one or more pieces of information can also be left out or replaced by a corresponding block or part of the block or one or more pieces of information.

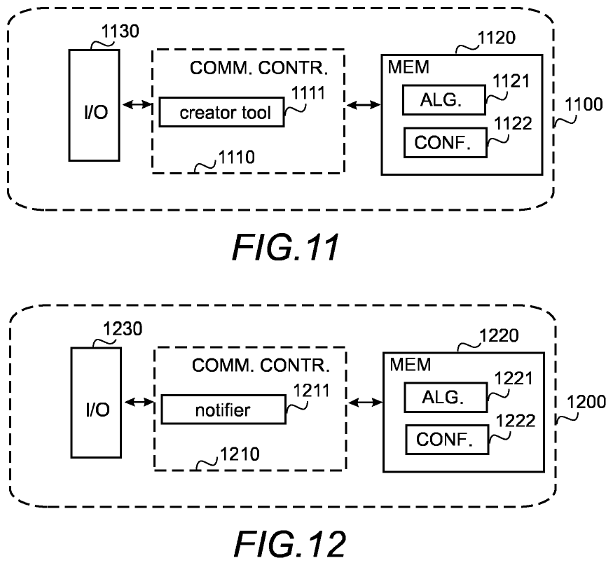

FIGS. 11 and 12 illustrate apparatuses comprising a communication controller 1110, 1210 such as at least one processor or processing circuitry, and at least one memory 1120, 1220 including a computer program code (software, algorithm) ALG. 1121, 1221, wherein the at least one memory and the computer program code (software, algorithm) are configured, with the at least one processor, to cause the respective apparatus to carry out any one of the embodiments, examples and implementations described above. FIG. 11 illustrates an apparatus configured to provide a front end apparatus, and FIG. 12 illustrates an apparatus configured at least to process (explicit) notification requests to notifications and to cause sending notifications. Naturally, the apparatuses may be merged, i.e. the apparatus may be configured to receive inputs or other information creating notification requests and to process them to notifications which are sent. The apparatuses of FIGS. 11 and 12 may be electronic devices.

Referring to FIGS. 11 and 12, the memory 1120, 1220 may be implemented using any suitable data storage technology, such as semiconductor based memory devices, flash memory, magnetic memory devices and systems, optical memory devices and systems, fixed memory and removable memory. The memory may comprise a configuration storage CONF. 1121, 1221, such as a configuration database, for at least storing one or more configurations and/or corresponding parameters/parameter values, for example for a tool to be displayed or for different rules. The memory 1120, 1220 may further store any other data.

Referring to FIG. 11, the apparatus 1100 may further comprise a communication interface 1130 comprising hardware and/or software for realizing communication connectivity at least according to one or more communication protocols. The communication interface 1130 may provide the apparatus with communication capabilities with an apparatus configured at least to process notification requests to notifications, for example with a user data management node. The communication interface may comprise standard well-known analog communication components such as an amplifier, filter, frequency-converter and circuitries, conversion circuitries transforming signals between analog and digital domains, and possibly one or more antennas. Digital signal processing regarding transmission and/or reception of signals may be performed in a communication controller 1110.

The apparatus 1100 may further comprise an application processor (not illustrated in FIG. 11) executing one or more computer program applications that generate a need to transmit and/or receive data. The application processor may execute computer programs forming the primary function of the apparatus.

The communication controller 1110 may comprise one or more request creating tools 1111 (creator tool) configured to display fields, receive user inputs to fields, create and cause transmissions of (explicit) notification requests according to any one of the embodiments/examples/implementations described above.

Referring to FIG. 12, the apparatus configured at least to process (explicit) notification requests to notifications and to cause sending notifications comprises a communication interface 1230 comprising hardware and/or software for realizing communication connectivity according to one or more communication protocols. The communication interface 1230 may provide the apparatus with communication capabilities with one or more front end apparatuses and communication capabilities provide the apparatus with communication capabilities with one or more nodes (apparatuses) of a wireless network. The communication interface may comprise standard well-known components such as an amplifier, filter, frequency-converter, (de)modulator, and encoder/decoder circuitries and one or more antennas.

The apparatus 1200 may further comprise one or more application processors (not illustrated in FIG. 12) executing one or more computer program applications that generate a need to transmit and/or receive data. The one or more application processor may execute computer programs forming the primary function of the apparatus, for example different user data management functions.

The communication controller 1210 comprises a notifier circuitry 1211 configured to process received (explicit) notification requests to notifications according to any one of the embodiments/examples/implementations described above. The notifier circuitry may comprise the trigger processing entity and/or a rule-based machine learning tool.

In an embodiment, at least some of the functionalities of the apparatus of FIG. 12 may be shared between two physically separate devices, forming one operational entity. Therefore, the apparatus may be seen to depict the operational entity comprising one or more physically separate devices for executing at least some of the processes described with respect to the apparatus at least processing notification requests to notifications.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone (smart phone) or a similar integrated circuit in a server, a cellular network device, or another network device.

In an embodiment, at least some of the processes described in connection with FIGS. 2 to 10 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments comprises a circuitry including at least one processor and at least one memory including computer program code. When activated, the circuitry causes the apparatus to perform (carry out) at least some of the functionalities according to any one of the embodiments/examples/implementations of FIGS. 2 to 10, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus (es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems (apparatuses) described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 10 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-16. (canceled)

17. An apparatus comprising
at least one processor; and
at least one memory including computer program code, the at least one memory and computer program code configured to, with the at least one processor, cause the apparatus at least to perform:
receiving a request for an explicit notification to one or more serving nodes, the request containing at least information on one or more network nodes to be notified, information on mobile subscription identifiers the notification relates to, and a process to be performed; and
causing sending, per a network node, to the one or more network nodes an explicit notification to perform the process, the explicit notification comprising the information on mobile subscription identifiers.

18. The apparatus according to claim 17, wherein the at least one memory and computer program code configured to, with the at least one processor, cause the apparatus further to at least to perform:
determining, in response to the information on one or more network nodes to be notified comprising one or more network function types and one or more service names, the one or more network nodes by performing a network function endpoint discovery.

19. The apparatus according to claim 17, wherein the at least one memory and computer program code configured to, with the at least one processor, cause the apparatus further to at least to perform:
using, in response to the request comprising one or more public mobile network identifiers, also the one or more public mobile network identifiers when determining the one or more network nodes.

20. The apparatus according to claim 17, wherein the at least one memory and computer program code configured to, with the at least one processor, cause the apparatus further to at least to perform:
determining, in response to the request containing default call back address information without authority and one or more service names, one or more default call back addresses by performing a network function endpoint discovery based on the one or more network nodes and the one or more service names.

21. The apparatus according to claim 17, wherein the request is received from a front end apparatus.

22. The apparatus according to claim 17, wherein the request is received from a rule-based tool.

23. The apparatus according to claim 22, wherein the at least one memory and computer program code configured to, with the at least one processor, cause the apparatus further to at least to perform:
providing the rule-based tool as a rule based machine learning tool, configured to determine, based on one or more rules, information on mobile subscription identifiers an explicit notification should be created, and a process to be performed, and to create the request correspondingly.

24. The apparatus according to claim 23, wherein the at least one memory and computer program code configured to, with the at least one processor, cause the apparatus further to at least to perform:
monitoring changes in data relating to subscription information;
checking, in response to detecting a change relating to subscription information, whether one or more rules apply; and
causing creating and sending a request in response to one or more rules applying.

25. A method comprising:
receiving a request for an explicit notification to one or more serving nodes, the request containing at least information on one or more network nodes to be notified, information on mobile subscription identifiers the notification relates to, and a process to be performed; and
causing sending, per a network node, to the one or more network nodes an explicit notification to perform the process, the explicit notification comprising the information on mobile subscription identifiers.

26. A computer program comprising instructions which, when the program is executed by an apparatus, cause the apparatus apparatus to carry out at least one of a first method or a second method,
wherein the first method comprises at least:
providing a user a tool to request explicit notification, the tool comprising, a field for information on one or more network nodes to be notified, a field for at least one default callback address information, a field for one or more unified data management endpoints, a field for information on mobile subscription identifiers the notification relates to, a field for changed data, and selection options, which define processes to be performed, the processes comprising data synchronization, deregistering and initiating reload of data;
receiving as user input in the tool at least information on one or more network nodes to be notified, one or more user device context management service name as the one or more unified data management endpoints and information on mobile subscription identifiers the notification relates to;
creating, in response to a user input selecting one of the selection options, per a unified data management endpoint, a request for an explicit notification, the request containing received user input and the selected process; and
causing sending, per the unified data management endpoint, the request to the unified data management endpoint to cause performance of the selected process;
wherein the second method comprises at least:
receiving a request for an explicit notification to one or more serving nodes, the request containing at least information on one or more network nodes to be notified, information on mobile subscription identifiers the notification relates to, and a process to be performed; and
causing sending, per a network node, to the one or more network nodes an explicit notification to perform the process, the explicit notification comprising the information on mobile subscription identifiers.
